(19) United States
(12) Patent Application Publication
(10) Pub. No.: US 2026/0031912 A1
(43) Pub. Date: Jan. 29, 2026

(54) ELECTRONIC DESIGN AUTOMATION SYSTEM

(71) Applicant: JESS-LINK PRODUCTS CO., LTD., New Taipei City (TW)

(72) Inventor: Chi-Hsien SUN, New Taipei City (TW)

(21) Appl. No.: 18/823,704

(22) Filed: Sep. 4, 2024

(30) Foreign Application Priority Data
Jul. 29, 2024 (TW) 113128091

(51) Int. Cl. H04B 10/40

(52) U.S. Cl. CPC H04B 10/40

(57) ABSTRACT

An electronic design automation system includes a data-computing subsystem. The data-computing subsystem includes a data-computing apparatus and a plurality of active optical cable optical transceivers. The data-computing apparatus includes a data-computing circuit and a plurality of connection ports. The active optical cable optical transceiver includes a signal recovery chip, an optical signal transmitter, and an optical signal receiver. The active optical cable optical transceiver inserts into the connection port to be electrically connected to the data-computing circuit. The signal recovery chip is electrically connected to the data-computing circuit through the connection port. The optical signal transmitter and the optical signal receiver are electrically connected to the signal recovery chip.

### BACKGROUND OF THE DISCLOSURE

### Technical Field

The present disclosure relates to an electronic design system, and especially relates to an electronic design automation system.

### Description of Related Art

In the semiconductor field, a related art electronic design automation (commonly referred to as EDA) technology is often utilized to achieve the circuit design and the circuit development. In order to meet the increasingly complex and diverse semiconductor design requirements, the related art electronic design automation technology must be upgraded in the amount of the data computation.

The related art electronic design automation technology adopts related art digital signal processing (commonly referred to as DSP) chips. However, the related art digital signal processing chips have higher signal transmission delay and higher power consumption, so that the computing ability (namely, the computing power or the hash rate) and the capability of the related art electronic design automation technology may no longer satisfy the current requirement.

### SUMMARY OF THE INVENTION

In order to solve the above-mentioned problems, an object of the present disclosure is to provide an electronic design automation system.

In order to achieve the object of the present disclosure mentioned above, the electronic design automation system of the present disclosure includes a data-computing subsystem which is used in an electronic design automation field. Moreover, the data-computing subsystem includes a data-computing apparatus and a plurality of active optical cable optical transceivers. The active optical cable optical transceivers are electrically connected to the data-computing apparatus. Moreover, the data-computing apparatus includes a data-computing circuit and a plurality of connection ports. The active optical cable optical transceiver inserts into the connection port to be electrically connected to the data-computing circuit. Moreover, the active optical cable optical transceiver includes a signal recovery chip, an optical signal transmitter, and an optical signal receiver. The signal recovery chip is electrically connected to the data-computing circuit through the connection port. The optical signal transmitter is electrically connected to the signal recovery chip. The optical signal receiver is electrically connected to the signal recovery chip.

Moreover, in an embodiment of the electronic design automation system of the present disclosure mentioned above, the signal recovery chip is a clock data recovery integrated circuit.

Moreover, in an embodiment of the electronic design automation system of the present disclosure mentioned above, the data-computing apparatus is a field programmable gate array computing apparatus; the data-computing circuit is a field programmable gate array computing circuit.

Moreover, in an embodiment of the electronic design automation system of the present disclosure mentioned above, the data-computing subsystem further includes a switch electrically connected to the data-computing circuit.

Moreover, in an embodiment of the electronic design automation system of the present disclosure mentioned above, the data-computing subsystem further includes a data storage apparatus electrically connected to the data-computing circuit.

Moreover, in an embodiment of the electronic design automation system of the present disclosure mentioned above, the electronic design automation system is applied to a first external electronic apparatus and a second external electronic apparatus. The electronic design automation system includes a plurality of the data-computing subsystems. Moreover, the data-computing subsystems include a first data-computing subsystem and a second data-computing subsystem. The switch of the first data-computing subsystem is electrically connected to the first external electronic apparatus. The switch of the second data-computing subsystem is electrically connected to the second external electronic apparatus. The optical signal transmitters and the optical signal receivers of the active optical cable optical transceivers of the first data-computing subsystem are electrically connected to the optical signal transmitters and the optical signal receivers of the active optical cable optical transceivers of the second data-computing subsystem.

Moreover, in an embodiment of the electronic design automation system of the present disclosure mentioned above, the electronic design automation system further includes a plurality of at least one fiber optic cables. Moreover, the optical signal transmitters and the optical signal receivers of the active optical cable optical transceivers of the first data-computing subsystem are connected to the optical signal transmitters and the optical signal receivers of the active optical cable optical transceivers of the second data-computing subsystem through the at least one fiber optic cables. Each of the at least one fiber optic cables includes one branch or N branches. The N is an even number greater than zero.

Moreover, in an embodiment of the electronic design automation system of the present disclosure mentioned above, the N is eight.

Moreover, in an embodiment of the electronic design automation system of the present disclosure mentioned above, the data-computing subsystems further include a third data-computing subsystem. The optical signal transmitters and the optical signal receivers of the active optical cable optical transceivers of the first data-computing subsystem are connected to the optical signal transmitters and the optical signal receivers of the active optical cable optical transceivers of the third data-computing subsystem through the at least one fiber optic cables.

The advantage of the present disclosure is to reduce the signal transmission delay and the power consumption of the electronic design automation.

Please refer to the detailed descriptions and figures of the present disclosure mentioned below for further understanding technologies, methods, and effects and achieving the predetermined purposes of the present disclosure. Further, the purposes, characteristics, and features of the present disclosure may be more deeply and specifically understood. However, the drawings are provided only for references and descriptions and not intended to limit the scope of the present disclosure.

### BRIEF DESCRIPTION OF THE DRAWINGS

FIG. 1 shows a block diagram of the first embodiment of the electronic design automation system of the present disclosure.

FIG. 2 shows a block diagram of the second embodiment of the electronic design automation system of the present disclosure.

FIG. 3 shows a block diagram of the third embodiment of the electronic design automation system of the present disclosure.

### DETAILED DESCRIPTION

In the present disclosure, numerous specific details are provided, to provide a comprehensive understanding of embodiments of the present disclosure. However, those skilled in the art may understand that the present disclosure may be practiced without one or more of these specific details. In other instances, well-known details are not shown or described to avoid obscuring features of the present disclosure. The technical content and the detailed description of the present disclosure are as follows with reference to the figures.

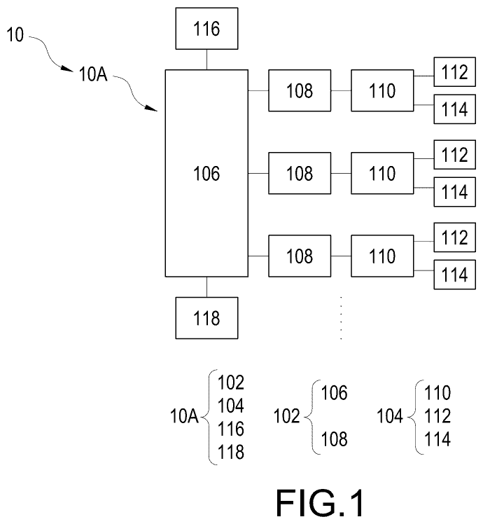

FIG. 1 shows a block diagram of the first embodiment of the electronic design automation (commonly referred to as EDA) system 10 of the present disclosure. The electronic design automation system 10 of the present disclosure includes a data-computing subsystem (namely, a first data-computing subsystem 10A, wherein the data-computing subsystem may also be called an electronic design automation data-computing subsystem) which is used in an electronic design automation field. The data-computing subsystem (namely, the first data-computing subsystem 10A) includes a data-computing apparatus 102, a plurality of active optical cable (commonly referred to as AOC) optical transceiver 104, a switch 116, and a data storage apparatus 118. The data-computing apparatus 102 includes a data-computing circuit 106 and a plurality of connection ports 108. The active optical cable optical transceiver 104 includes a signal recovery chip 110, an optical signal transmitter 112, and an optical signal receiver 114.

The data-computing circuit 106 is electrically connected to the switch 116, the data storage apparatus 118, and the connection ports 108. The active optical cable optical transceiver 104 inserts into the connection port 108 to be electrically connected to the data-computing circuit 106. The signal recovery chip 110 is electrically connected to the data-computing circuit 106 through the connection port 108. The optical signal transmitter 112 and the optical signal receiver 114 are electrically connected to the signal recovery chip 110.

The data-computing apparatus 102 is, for example but not limited to, a field programmable gate array (commonly referred to as FPGA) computing apparatus. The data-computing circuit 106 is, for example but not limited to, a field programmable gate array computing circuit. The signal recovery chip 110 is, for example but not limited to, a clock data recovery (commonly referred to as CDR) integrated circuit. The clock data recovery integrated circuit (namely, the signal recovery chip 110) features low signal transmission delay, low power consumption, and low thermal consumption. The data storage apparatus 118 is, for example but not limited to, a hard disk.

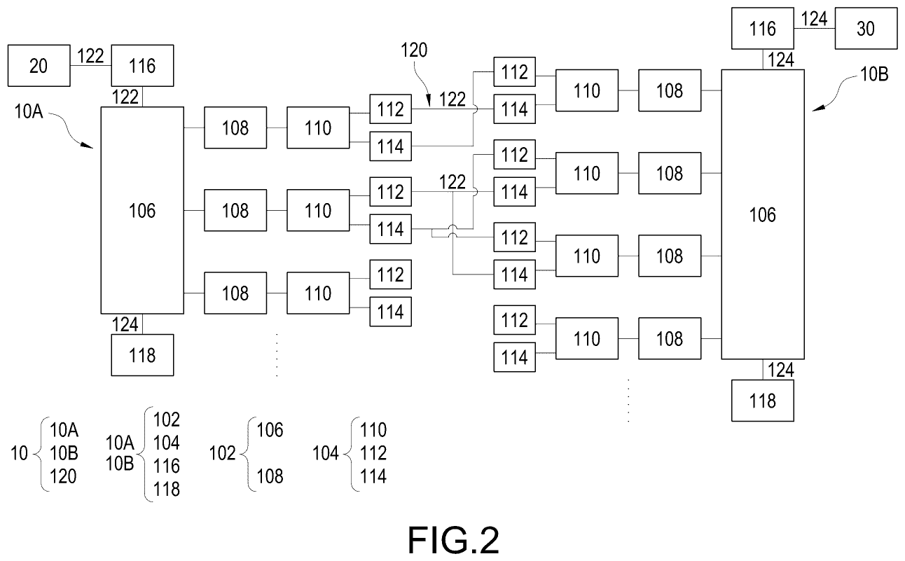

FIG. 2 shows a block diagram of the second embodiment of the electronic design automation system 10 of the present disclosure. The descriptions of the elements shown in FIG. 2 which are the same as the elements shown in FIG. 1 are not repeated here for brevity. The electronic design automation system 10 further includes a plurality of at least one fiber optic cables 120. The electronic design automation system 10 is applied to a first external electronic apparatus 20 and a second external electronic apparatus 30. The electronic design automation system 10 includes a plurality of the data-computing subsystems. The data-computing subsystems include the first data-computing subsystem 10A and a second data-computing subsystem 10B. Each of the at least one fiber optic cables 120 includes one branch or N branches. The N is an even number greater than zero (for examples, two, four, six, eight . . . ). If the N is larger (for example, eight), the power consumption of the present disclosure may be better dispersed to substantially increase the computing ability (namely, the computing power or the hash rate) of the present disclosure.

The switch 116 of the first data-computing subsystem 10A is electrically connected to the first external electronic apparatus 20. The switch 116 of the second data-computing subsystem 10B is electrically connected to the second external electronic apparatus 30. The optical signal transmitters 112 and the optical signal receivers 114 of the active optical cable optical transceivers 104 of the first data-computing subsystem 10A are electrically connected to the optical signal transmitters 112 and the optical signal receivers 114 of the active optical cable optical transceivers 104 of the second data-computing subsystem 10B through the at least one fiber optic cables 120.

Moreover, the switch 116 of the first data-computing subsystem 10A is used to download a computation data 122 from the first external electronic apparatus 20 and transmit the computation data 122 to the data-computing circuit 106 of the data-computing apparatus 102 of the first data-computing subsystem 10A. The data-computing circuit 106 of the data-computing apparatus 102 of the first data-computing subsystem 10A cooperates with the data-computing circuit 106 of the data-computing apparatus 102 of the second data-computing subsystem 10B through the optical signal transmitters 112, the optical signal receivers 114, and the at least one fiber optic cables 120, to compute the computation data 122 to obtain a computation result 124. The data storage apparatus 118 is used to store the computation result 124. The switch 116 of the second data-computing sub-system 10B transmits the computation result 124 to the second external electronic apparatus 30.

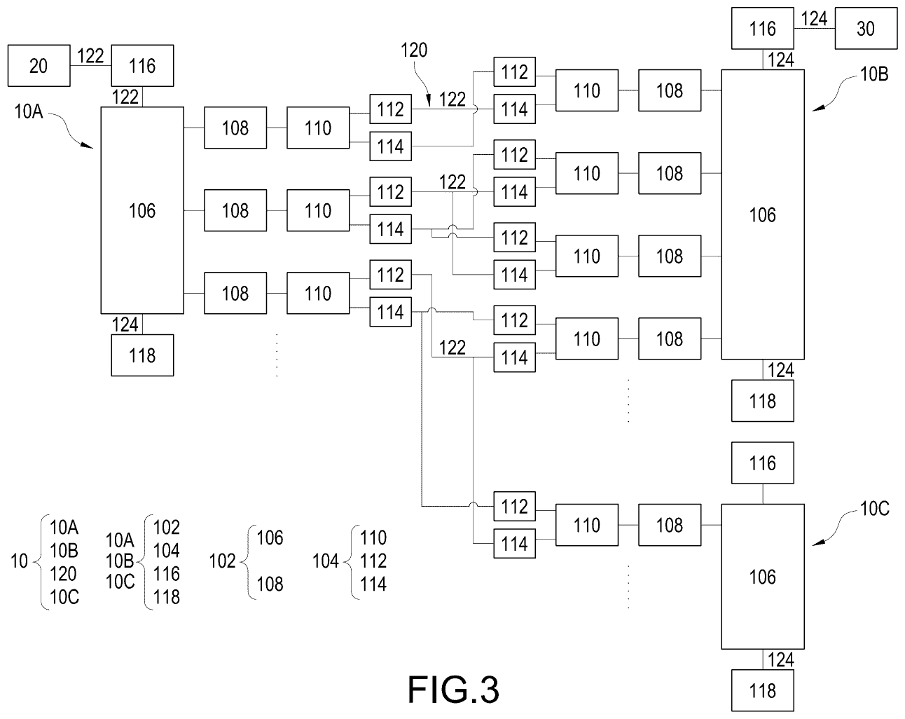

FIG. 3 shows a block diagram of the third embodiment of the electronic design automation system 10 of the present disclosure. The descriptions of the elements shown in FIG. 3 which are the same as the elements shown in FIG. 2 are not repeated here for brevity. The data-computing subsystems further include a third data-computing subsystem 10C. The optical signal transmitters 112 and the optical signal receivers 114 of the active optical cable optical transceivers 104 of the first data-computing subsystem 10A are connected to the optical signal transmitters 112 and the optical signal receivers 114 of the active optical cable optical transceivers 104 of the third data-computing subsystem 10C through the at least one fiber optic cables 120.

The advantage of the present disclosure is to reduce the signal transmission delay and the power consumption of the electronic design automation, to further increase the computing ability (namely, the computing power or the hash rate) of the electronic design automation. In the electronic design automation field, the present disclosure may use the data-computing subsystems to operate simultaneously to distribute the computing load. The present disclosure may be applied to the optical transceiver modules in the semiconductor field. The at least one fiber optic cables 120 may be wound with a large bending angle to fit into servers (not shown in the drawings). The present disclosure uses the active optical cable to connect to the data-computing subsystems instead of the copper wire with a thicker diameter.

Although the present disclosure has been described with reference to the embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure.

What is claimed is:

1. An electronic design automation system comprising:
a data-computing subsystem used in an electronic design automation field,
wherein the data-computing subsystem comprises:
a data-computing apparatus; and
a plurality of active optical cable optical transceivers electrically connected to the data-computing apparatus,
wherein the data-computing apparatus comprises:
a data-computing circuit; and
a plurality of connection ports, wherein the active optical cable optical transceiver inserts into the connection port to be electrically connected to the data-computing circuit,
wherein the active optical cable optical transceiver comprises:
a signal recovery chip electrically connected to the data-computing circuit through the connection port;
an optical signal transmitter electrically connected to the signal recovery chip; and
an optical signal receiver electrically connected to the signal recovery chip.

2. The electronic design automation system of claim 1, wherein the signal recovery chip is a clock data recovery integrated circuit.

3. The electronic design automation system of claim 1, wherein the data-computing apparatus is a field programmable gate array computing apparatus; the data-computing circuit is a field programmable gate array computing circuit.

4. The electronic design automation system of claim 1, wherein the data-computing subsystem further comprises:
a switch electrically connected to the data-computing circuit.

5. The electronic design automation system of claim 1, wherein the data-computing subsystem further comprises:
a data storage apparatus electrically connected to the data-computing circuit.

6. The electronic design automation system of claim 4, wherein the electronic design automation system is applied to a first external electronic apparatus and a second external electronic apparatus; the electronic design automation system comprises a plurality of the data-computing subsystems; the data-computing subsystems comprise a first data-computing subsystem and a second data-computing subsystem; the switch of the first data-computing subsystem is electrically connected to the first external electronic apparatus; the switch of the second data-computing subsystem is electrically connected to the second external electronic apparatus; the optical signal transmitters and the optical signal receivers of the active optical cable optical transceivers of the first data-computing subsystem are electrically connected to the optical signal transmitters and the optical signal receivers of the active optical cable optical transceivers of the second data-computing subsystem.

7. The electronic design automation system of claim 6, further comprising:
a plurality of at least one fiber optic cables,
wherein the optical signal transmitters and the optical signal receivers of the active optical cable optical transceivers of the first data-computing subsystem are connected to the optical signal transmitters and the optical signal receivers of the active optical cable optical transceivers of the second data-computing subsystem through the at least one fiber optic cables; each of the at least one fiber optic cables comprises one branch or N branches; the N is an even number greater than zero.

8. The electronic design automation system of claim 7, wherein the N is eight.

9. The electronic design automation system of claim 7, wherein the data-computing subsystems further comprise a third data-computing subsystem; the optical signal transmitters and the optical signal receivers of the active optical cable optical transceivers of the first data-computing subsystem are connected to the optical signal transmitters and the optical signal receivers of the active optical cable optical transceivers of the third data-computing subsystem through the at least one fiber optic cables.
